(19) United States
(12) Patent Application Publication
(10) Pub. No.: US 2014/0337034 A1
(43) Pub. Date: Nov. 13, 2014

(54) SYSTEM AND METHOD FOR ANALYSIS OF POWER RELATIONSHIPS AND INTERACTIONAL DOMINANCE IN A CONVERSATION BASED ON SPEECH PATTERNS

(71) Applicant: Avaya Inc., Basking Ridge, NJ (US)

(72) Inventors: Ajita JOHN, Holmdel, NJ (US); Vinodkumar PRABHAKARAN, Bronx, NY (US); Doree Duncan SELIGMANN, New York, NY (US)

(73) Assignee: Avaya Inc., Basking Ridge, NJ (US)

(21) Appl. No.: 14/036,868

(22) Filed: Sep. 25, 2013

Related U.S. Application Data
(60) Provisional application No. 61/821,869, filed on May 10, 2013.

(51) Int. Cl. G10L 25/48

(52) U.S. Cl. CPC G10L 25/48
USPC 704/270

(57) ABSTRACT

Disclosed herein are systems, methods, and non-transitory computer-readable storage media for evaluating dominance of participants in a conversation or interaction. An example system configured to practice the method first receives interaction data involving a plurality of participants, and can identify a type of interaction based on the interaction data. The system can parse the interaction data to identify dialog turns, and extract, from the interaction data and dialog turns, a plurality of participant features, wherein the plurality of participant features is selected based on the type of interaction. Then the system can generate, for each of the plurality of participants, a power index based on the respective participant features.

### RELATED APPLICATION

This application claims priority to U.S. Provisional Patent Application No. 61/821,869, filed 10 May 2013, the entire contents of which are herein incorporated by reference in their entirety.

### BACKGROUND

1. Technical Field

The present disclosure relates to speech analysis and more specifically to identifying, based on speech interaction data, power relationships in a group of speakers.

2. Introduction

In any given conversation involving multiple participants, one or more speakers might have greater dominance and influence over the others. For example, in a conversation between a military officer and a subordinate, between a professor and students, or between an incumbent and a challenger in a political election, one or more speakers are typically more dominant and powerful than others for reasons both internal and external to the conversation. It is often useful to know who among the participants has the most dominant posture in the communication. This person will tend to be more prominent than others and may have more influence even outside of the context of the communication. In contrast, some participants may occupy a more passive or subservient role in a conversation and even be overshadowed by others. Understanding such dynamics among different participants in a communication can provide a better picture of the interpersonal relationship that they occupy and help assessing strengths, weaknesses, or conflicts among the participants. One way to determine conversational dominance is to have humans listen to the conversation and evaluate or rank the speakers, however this approach is costly, time consuming, and human evaluators have variations in how they rank dominance. Automatic detection of power relationships and interactional dominance in a conversation poses a special challenge because such information can usually be elicited only from subtle cues that are hard to detect. Explicit queries are usually out of the question in such situations.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed herein are approaches for evaluating interpersonal power relationships and interactional dominance by analyzing various speech patterns in a conversation. The analysis includes scrutinizing how the participants talk, how often they talk, how they interact with the others in the group, how the others react, and so forth. Specifically, the analysis relies on at least three observations derived from empirical evidence about the dominant people in a conversation. First, dominant people tend to talk more than others and also get asked more questions. Second, moderators, if there are any, give dominant speakers more talk time and direct more questions at them. Third, other speakers tend to mention dominant speakers more often and interrupt dominant speakers more often.

The analysis can incorporate data generated by voice recognition or speech recognition technologies applied to the conversation. For example, identifying each speaker in a conversation and understanding the context of the conversation can help determine when each speaker has spoken and for how long, whether each spoken line of dialogue was a statement or a query, a complete sentence or not, and so forth. The system can perform the analysis in real time or on recorded conversations. In the case of a real-time or substantially real-time analysis of a live conversation, a bridging or recording system that tracks dominance can display or output a dominance ranking or other information generated by the analysis, such as for a moderator, an audience, or for participants in the conversation. Such a bridging or recording system can also automatically provide information from speaker identification, speaker tone, and other speaker attributes. This approach offers a quantifiable process for finding dominant speakers in a conversation in an automated, and predictable way. The system can automatically detect power relationships and interactional dominance by analyzing speech patterns such as duration of speech, number of questions asked, and interactions with the moderator and other people.

Disclosed are systems, methods, and non-transitory computer-readable storage media for detecting power relationships in a conversation. An example system configured to perform the method receives a conversation involving a moderator and a plurality of participants, wherein the conversation is one of a spoken dialogue and a written transcript. Then the system can analyze the conversation to yield a conversation analysis, wherein the analyzing is based on one of a comparative duration of speech belonging to each of the plurality of participants, a number of questions directed at each of the plurality of participants, an amount of time the moderator allocates to each of the plurality of participants, a number of questions that the moderator directs at each of the plurality of participants, a number of times a name of each of the plurality of participants is mentioned, and a number of times each of the plurality of participants is interrupted. The system can rate each of the plurality of participants with an interaction dominance score based on the conversation analysis.

Some example applications of this approach to specific experimental data and further details of how to identify dominant participants in an interaction are provided herein. Identification of dominant participants can have numerous practical applications. An automatic system can rank participants of an interaction in terms of their relative power based on several linguistic and structural features of the interaction. The illustrative example used to demonstrate these principles is the 2012 Republican presidential primary debates. This example dataset includes textual transcripts of 20 debates with 4-9 candidates as participants per debate. The power index of each candidate is modeled in terms of their relative poll standings in the state and national polls. The candidates' power indices affected the way they interacted with others and the way others interacted with them. Conversational dominance scores can be determined for virtually any genres of recorded or live interactions of multi-party conversations.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example timeline of debates and primaries;

FIG. 2 illustrates an example chart of Power Index P(X) over time for the example timeline of debates and primaries;

FIG. 3 illustrates an example system for processing conversations;

FIG. 4 illustrates an example method embodiment; and

FIG. 5 illustrates an example computing system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Social interactions in online environments have steadily grown over the last several decades, such as conversations on web pages, forums, online chats, discussion forums, social networks, and so forth. Even interactions in formerly offline environments are now increasingly presented in online environments, such as broadcast events, debates and speeches. News media outlets and video sharing sites such as YouTube can store such interactions for later retrieval over a long period. This growing mass of public data representing various modes of interactions enables researchers to computationally analyze social interactions at a scale not feasible previously. Disclosed herein are systems, methods, and computer-readable media for determining a power, dominance, or status difference between participants in such social interactions as reflected by the various facets of interactions using computational means.

When people interact with one another, a social-based or relationship-based power differential often affects the way they interact. This differential is typically based on a multitude of factors such as social status, authority, experience, age, and so forth. The exact factors and their respective weights can vary from culture to culture, and even from cultural subgroup to cultural subgroup within a same culture. For example, one culture may value age most highly, while another culture may value logic most highly.

Identifying the dominant participants of an interaction through a power ranking system could have various applications. For example, the ability to determine dominant participants in an interaction can improve effectiveness of advertisements within online communities by creating, tailoring, and targeting an advertisement to powerful and influential members within an online community to increase its effectiveness and reach to the community members. Participant dominance analysis can also help in information retrieval systems. Revealing power dynamics within stored interactions in online forums and communities can be useful in determining relevance for a user with information needs. For example, a user may want to limit his search to posts authored by participants with higher power, influence, respect, or dominance.

Dominance analysis may also aid intelligence agencies to detect leaders and influencers in suspicious online communities. This is especially useful since the real identities of the members of such communities are often not revealed and the hierarchies of such communities may not be available to the intelligence agencies. Then the intelligence agencies can focus intelligence gathering efforts on the individuals identified as being leaders or influencers. Further, even as the mix of participants shifts over time, the intelligence agencies can begin to determine where participants are situated in the hierarchy.

Existing computational efforts to analyze or predict power differentials between participants of interactions by relying on static power structures or hierarchies as sources for the power differential. This approach is independent of a static power structure and does not rely on any previous knowledge of an existing hierarchy, which can be helpful in situations where interactions happen outside the context of a pre-defined static power structure or hierarchy. Examples for such interactions include political debates, online discussion forums, and email interactions outside organizational boundaries. Although the participants of these interactions may or may not be part of an established power structure, there is often a power differential between them drawn from various other factors such as popularity, experience, knowledge, etc. In such situations, the interaction itself plays an important role as a medium for the participants to pursue, gain and maintain power over others. Consequently, the manifestations of power in such interactions will also be inherently different from the cases where a hierarchy is present. Political debates are one specific example type of interaction where the power differential is exceptionally dynamic.

In the example of the 2012 Republican presidential primary debates, an automatic ranking system ranked debate participants in terms of their relative power. The automatic ranking system modeled the power of each candidate in terms of their relative standings in the polls released prior to the debate. The candidates' power indices often correlated to the way they interacted with others and the way others interacted with them. Political debates provided a particularly illustrative example domain, because the primary objective of the debate participants is to pursue and maintain power over each other, as opposed to operating within a static power structure.

Social power and how it affects the ways people behave in interactions have been studied extensively in social sciences and psychology. The language, tone, and structure of interactions even in small group conversations can reflect power, dominance, and influence. The structure of conversations (e.g. frequency of turns) can reflect dominance because time spent speaking in a small group can be interpreted effectively an exercise of power over the other members for at least the duration of the time taken, regardless of the content. Thus, conversational turns gained by interruptions can be stronger indicators of power than turns gained otherwise. Further, the content of the dialog turns taken by individuals can also play a role in influence. These linguistic context and content indicators can help identify relative status between individuals in social interactions. Other indicators of status or dominance in a conversation can include politeness, for example. Various non-textual information can be immensely useful for determining dominance in a conversation. Thus, while the approaches and principles set forth herein can apply to text documentation of interactions, a spoken audio or video interaction corpus may provide better or more accurate results.

An automatic ranking system can rely on other sources of information to augment the results from a dominance analysis, such as using meta-data about email messages in an email thread to determine who sent how many message to whom and when. The automatic ranking system can also incorporate additional information such as language coordination, a metric that measures the extent to which a participant adopts another's language style. The automatic ranking system can analyze other factors such as topic control, task control, involvement, disagreement, attempts to persuade, agreement, disagreement, and various dialog patterns. The automatic ranking system can analyze factors beyond pure lexical features and use dialog structure based features of spoken interactions. The automatic ranking system can analyze interactions expressly made for the purpose of pursuing and/or maintaining power or dominance in situations where domain candidates may gain or lose power over the course of interactions, instead of situations where the power or dominance hierarchy is rigid or fixed. The automatic ranking system can also analyze interactions that are time-bound, such as a real-time political debate, in contrast to strictly online discussions such as a Wikipedia or other online text-based forum.

An experimental automatic ranking system was applied to an example corpus of a primary election political debate. Before the United States presidential election, a series of presidential primary elections are typically held in several U.S. states by major political parties to select their respective presidential nominees. In recent times, it has become customary for candidates of both parties engage in a series of intra-party debates with other candidates of the same political party prior to and during their respective parties' primary elections. FIG. 1 illustrates an example timeline 100 of debates and primaries. In this example, the series of debates 102 starts long before and partially overlaps with the actual presidential primaries 104 in each state. Using this body of interactions, the automatic ranking system can explore changes in dominance of various political candidates. Specifically, the automatic ranking system analyzed the 20 debates held between May 2011 and February 2012 as part of the 2012 Republican presidential primaries. A total of 10 candidates participated in these primary debates, and some candidates only participated in one or two debates. Interactions in these debates are fairly well structured and typically follow a pattern of a moderator asking questions and candidates responding, with some disruptions due to interruptions from other candidates.

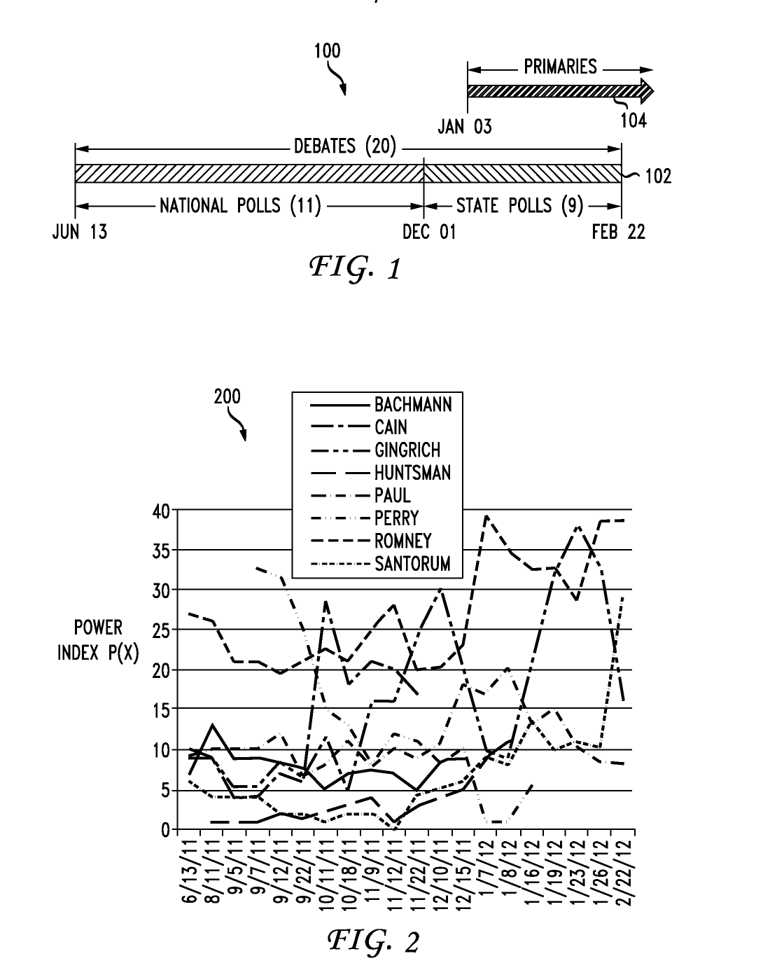

Presidential debates serve an important role during the election process. Presidential debates are a platform for candidates to discuss and explain their stances on policy issues, and to persuade or sway voters, perhaps by contrasting their own positions with other candidates' stances. In addition, presidential debates also serve as a medium for the candidates to pursue and maintain power over other candidates. This attribute makes presidential debates an interesting domain to investigate how power dynamics between participants are manifested in an interaction. In addition, the 2012 Republican presidential election campaign was one of the most volatile series of debates in recent times. A greater than usual number of candidates held the frontrunner position at some point during the series of debates. This peculiar situation prevents any analysis of power dynamics in these debates from being biased on the personal characteristics of a single candidate or a small set of candidates. FIG. 2 illustrates an example chart 200 of Power Index P(X) over time for the example timeline of debates and primaries. The chart 200 shows the trend of how power or dominance indices of candidates, which will be further defined below, varied across debates.

The term Power Index P(X) denotes the power, dominance, or confidence with which a candidate participates in the debate. Multiple factors can influence the Power Index of a candidate. For example, during the presidential primary election campaigns, candidates receive endorsements by various political personalities, political organizations, newspapers, and businesses. Such endorsements as well as the funds raised through campaigns can positively affect the Power Index of the candidate. However, a more important source of a candidate's power is their relative standing in recent poll scores. Poll scores provide the candidate a sense of how successful he/she is in convincing the electorate of his/her candidature, platform, and positions. The Power Index of each candidate can be based on his or her recent state or national poll standings as a dominant factor. The automatic ranking system can incorporate additional or other factors in different combinations and can weight the factors differently. For example, the automatic ranking system can also examine the funds raised, number and quality of endorsements received, or a rate of change of poll standings when calculating the Power Index.

For each debate D, the set of candidates participating in that debate is denoted by C_{D}. Date(D) denotes the date on which debate D was held and state(D) denote the state in which the debate was held. Debates from December 2011 onwards were held in states where the primaries were to be held in the near future. In these debates, candidates' standings in the respective state polls, rather than national polls, are an example dominating factor affecting the power, dominance, or confidence of candidates. For other debates, which occurred in a state not having a near state primary, national poll can provide an indication of dominance. refType denotes the type of the reference poll considered for debate D in the following equation:

$$refType = \{ \begin{matrix}state ( D ) , ifdate ( D ) > 12 / 01 / 11 \\ NAT , otherwise\end{matrix}$$

FIG. 1 shows the refTypes for each debate. For example, in the debates 102 prior to December 01, roughly corresponding to the beginning of the state primaries 104, the national polls provided an indication of dominance, while in the debates 102 after December 01, the state polls provided the indication of dominance. For each debate, the percentage of electorate supporting each candidate in the most recently released poll results (national or state) serves as the power index. In the case of multiple polls released on the same day most recent day, the power index can be generated based on some combination or averaging of the poll scores. For example, the straight mean of all the poll scores can provide the power index, or the poll scores can be weighted according to their estimated accuracy or based on the sample size of the polls. RefPolls(D) is the set of polls of type refType released on the most recent date on which one or more such polls were released before Date(D). The Powerindex, P(X), of candidate XεCD is defined according to the equation below:

$$P ( X ) = \frac{1}{\vert RefPolls ( D ) \vert} {\sum }_{i = 1}^{{\vert REfPolls ( D ) \vert}_{{p}_{i}}}$$

where pᵢ denotes the poll percentage candidate X got in the i-th poll in RefPolls(D).

The experimental data were obtained from the manual transcripts of presidential debates. The transcripts of all debates follow similar formats, with a few exceptions. Each debate's transcript lists the presidential candidates who participated and the moderator(s) of the debate. Transcripts demarcate speaker turns and also contain markups to denote applause, laughter, booing and crosstalk during the debates. The experimental corpus of data included 20 debates, 30-40 hours of interaction time, an average of 6.6 candidates per debate, 245.2 average turns per debate, and 20466.6 average words per debate. The system calculated the power indices based on state and/or national poll results. FIG. 2 shows a chart 200 of the trend of how the power indices of candidates varied across debates, and shows when each respective candidate either dropped out of the race or stopped participating in the debates. Of the ten candidates, seven of them (everyone except Johnson, Huntsman and Pawlenty) were among the top 3 candidates for at least three debates, making this corpus particularly interesting and instructive in terms of detecting dominance and changes in dominance in interactions. Transcripts can be annotated with various tags representing individual words, speaker turns, events in the transcript, commentator speech vs. participant speech, and so forth.

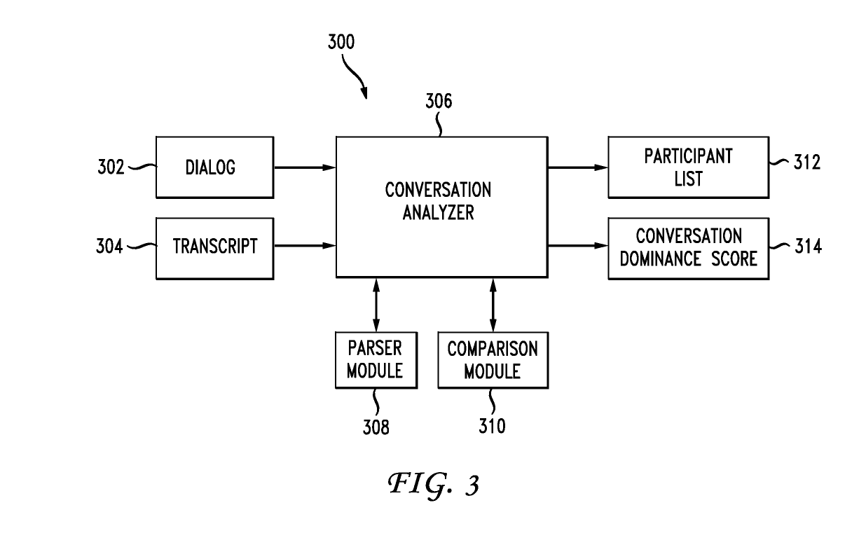

FIG. 3 illustrates an example automatic power or dominance ranking system 300 for processing conversations that uses supervised learning to rank the participants of the debates based on their power indices. Formally, given a debate D with a set of participants CD={x₁, x₂, . . . xₙ} and corresponding power indices denoted by P(xᵢ) for 1<i<n, the system 300 attempts to find a ranking function r: CD→{1 . . . n} such that for all 1<i,j<n, r(xᵢ)>r(xⱼ) [symbol] [symbol] P(xᵢ)>P(xⱼ). A support-vector machine based supervised learning system can estimate the ranking function r′ that gives an ordering of participants {x′₁, x′₂, x′ₙ}, optimizing on the number of inversions between the orderings produced by r′ and r. The conversation analyzer 306 receives the dialog 302 and the transcript 304 as inputs. An optional parser module 308 can parse the transcript 304 and/or the dialog 302 to determine the speaker turns of the various participants.

The comparison module 310 analyzes some of the ways in which power or dominance is manifested in participants' interactions. The comparison module 310 examines both conscious and subconscious choices participants make while engaging in the interactions, such as content choices, lexical choices, or choices participants make in terms of structure, how much to participate, and with what sort of contribution. In this example the comparison module 310 can consider what participants spoke (lexical features), how much participants spoke (verbosity features), how participants argued with each other (argument features), and how much others discussed the participant (mention features). Some structural features such as turns information are readily available from the transcripts or from the parser module 308, while some others, like arguments and candidate mentions, can be obtained by heuristics or perform deeper neuro-linguistic programming (NLP) analysis. The table below shows some example features that can be extracted from the dialog 302 and transcript 304 for use in determining a power index P(X).

| | |
|---|---|
| Code | Feature Description |

Lexical: What participants spoke

| | |
|---|---|
| WN | WordNgrams: Word sequence of length 1 to 5 |
| PN | PosNgrams: POS sequence of length 1 to 5 |

Verbosity: How much participants spoke

| | |
|---|---|
| WP | WordPercent: Percent of words spoken by participant X |
| TP | TurnPercent: Percent of turns by participant X |
| QP | QuestionPercent: Percent of questions addressed to participant X |
| WD | WordDev: WP—FairSharePercent(D) |
| TD | TurnDev: TP—FairSharePercent(D) |
| QD | QuestionDev: QP—FairSharePercent(D) |
| LT | LongestTurn: Number of words in the longest turn |

Argument: How long participants argued

| | |
|---|---|
| IO | InterruptOthers: Number of times participant X interrupted others |
| OI | Otherslnterrupt: Number of times others interrupted participant X |
| IOT | InterruptOthersPerTurn: Percent of participant X's turns that were interrupting |
| | others |
| OIT | OtherslnterruptPerTurn: Percent of participant X's turns that others interrupted |

Mentions: How often other spoke about a participant

| | |
|---|---|
| MC | MentionCount: Number of mentions of participant X |
| MP | MentionPercent: Percent of mentions of participant X |
| FNP | FirstNamePercent: Percent of mentions of participant X by first name |
| LNP | LastNamePercent: Percent of mentions of participant X by last name |
| FLNP | FirstAndLastNamePercent: Percent of mentions of participant X by first and |
| | last name |
| TNP | TitleAndNamePercent: Percent of mentions of participant X by title and name |

Lexical features refer to what participants said. Ngram based features can capture lexical patterns that denote power relations. The comparison module 310 can aggregate all turns of a participant and extract counts for word lemma ngrams (WN) and Part of Speech (POS) tag ngrams (PN). Verbosity refers to how much participants spoke in the interaction. The comparison module 310 can capture each participant's proportion of turns (TP), time duration each participant talked (WP) and number of questions posed to each participant (QP). The comparison module 310 can approximate the time duration each participant spoke by the total number of words spoken by him/her in the entire debate. To find the number of questions asked, the comparison module 310 can heuristically infer or deduce that instances where the participant spoke right after the moderator are questions the moderator posed to the participant. The percentage values of these features can depend on the number of participants in each debate, which in the test corpus varied between 4 and 9. To handle this, for each feature, the comparison module 310 can measure the deviation of each participant's percentage for that feature from its expected fair share percentage in the debate. The comparison module 310 can define the fair share percentage of a feature in a given debate to be the percentage each participant would receive for that feature, if equally distributed.

Formally, the comparison module 310 can define FairSharePercent(D) as

$$\frac{1}{\vert {C}_{D} \vert} .$$

The comparison module 310 can calculate the deviation of each feature (TD, WD and QD) as the difference between observed percentage for that feature and FairSharePercent(D). The comparison module 310 can also consider other structural features such as longest turn length (LT), words per turn (WT) describing whether participants had longer-than-average turns, or words per sentence (WS) describing whether participants used shorter sentences. The comparison module 310 can model arguments and interruptions in interactions leveraging the well-structured nature of interactions by using some heuristics to detect arguments and interruptions. Alternatively, the comparison module 310 can incorporate natural language processing and analysis of intent of participant turns to detect interruptions and arguments.

Debates, such as the presidential primary debates in the test corpus, follow a pattern where participants typically speak only after a moderator prompts him or her to either answer a question or to respond to another participant. Hence, if a participant talks immediately after another participant, he or she is disrupting the expected pattern of the debate. This holds true even if such an out-of-turn talk may not have interrupted the previous speaker midsentence.

The conversation analyzer 306 or the comparison module 310 can consider situations when a participant speaks out-of-turn after another participant as an interruption to the previous participant. In most cases in such debates, interruptions often lead to back-and-forth exchanges between the participants until a moderator steps in. The comparison module 310 can label such exchanges between participants where they talk with one another without the moderator intervening as an argument. Arguments can extend to multiple dialog turns. In counting interruptions, comparison module 310 can count only the first interruption by each candidate in the series of turns that constitute or mark the beginning of an argument. An example argument is provided below in which comparison module 310 counted only one instance of interruption for both Santorum and Romney.
SANTORUM: I would ask Governor Romney, do you believe people who have—who were felons, who served their time, who have extended—exhausted their parole and probation, should they be given the right to vote?
WILLIAMS: Governor Romney?
ROMNEY: First of all, as you know, the PACs that run ads on various candidates, as we unfortunately know in this—
SANTORUM: I'm looking for a question—an answer to the question first. [applause]
ROMNEY: We have plenty of time. I'll get there. I'll do it in the order I want to do. I believe that, as you realize that the super PACs run ads. And if they ever run an ad or say something that is not accurate, I hope they either take off the ad or make it—or make it correct. I guess that you said that they—they said that you voted to make felons vote? Is that it?
SANTORUM: That's correct. That's what the ad says.
ROMNEY: And you're saying that you didn't?
SANTORUM: Well, first, I'm asking you to answer the question, because that's how you got the time. It's actually my time. So if you can answer the question, do you believe, do you believe that felons who have served their time, gone through probation and parole, exhausted their entire sentence, should they be given the right to have a vote?
Excerpt from the debate held at Myrtle Beach, S.C. on Jan. 16, 2012

The counts of interruptions by participant X (IO) as well as interruptions by others while participant X was speaking (OI) can depend on the number of turns, so the comparison module 310 can also normalize counts to find the per-turn value as features (IOT, OIT).

The comparison module 310 can analyze mentions, or how often participants were talked about. How often others mention a participant in the debate is a good indicator of his or her power or dominance. The more a participant is mentioned, the more central he or she is in the context of that debate. The comparison module 310 can normalize the mention count across the total number of mentions of all candidates in a given debate (MP). In addition, the comparison module 310 can consider the form of addressing participants use while referring to each other. Some examples of the form of addressing participants can include FN (First Name), LN (Last Name), FLN (First and Last Name) and TN (Title followed by Name, first, last or full). Titles can include common titles such as Mr., Ms. etc. as well as a set of domain-specific title: Governor, Speaker, Senator, Congresswoman and Congressman. Example First Name references include “Newt” or “Mitt.” Example Last Name references include “Gingrich” or “Romney.” Example First and Last Name references include “Newt Gingrich” or “Mitt Romney.” Example Title references include “Mr. Newt Gingrich” or “Governor Romney.”

The comparison module 310 can analyze these features to correlate the word and turn features to participants' power indices. Participants with higher power indices spoke for significantly more time than others and also received a significantly greater number of turns in the interaction. The number of questions posed to the participant by a moderator also positively correlates to his or her power index. For example, the comparison module 310 can weakly correlate IO to the participant's Power Index, and moderately correlate OI to the participant's Power Index. However, as discussed before, IO and OI are dependent variables with TP which is already moderately positively correlated with the Power Index. Candidates with higher power indices are more likely to be interrupted in the setting of a presidential primary debate, in which participants are pursuing to gain power over each other. Thus, the specific correlations and relationships of these features in the interactions can vary based on the type of interaction. In a presidential primary debate, the correlation and mix of features is likely to be drastically different from the correlation and mix of features for analyzing participant dominance in a more collaborative meeting of business associates, or in a more neutral and less adversarial setting.

The comparison module 310 can strongly correlate absolute mention counts MC and its normalized measure MP, reflecting that as a participant gains more power or dominance, other participants mention him or her significantly more. However, in this particular corpus of text data, the distribution of mentions of a participant across different forms of addressing (FNP, LNP, TNP, FLNP) did not have any correlation with the power indices of the candidate, suggesting that while forms of addressing may be correlated with power relations in some situations, they are not affected by the short term variations of power as in the context of presidential primary debates. The comparison module 310 can still consider this feature of the dialog 302 and transcript 304 for other scenarios.

The comparison module 310 and/or the conversation analyzer 306 can perform natural language processing (NLP) analysis on the speaker turn texts after the parser module 308 identifies the speaker turns. The system 300 can tokenize the input, segment sentences, tag parts-of-speech, perform lemmatization, and tag named entities in the dialog 302 and/or transcript 304 prior to processing. Alternatively, the dialog 302 and transcript 304 can be completely or partially pre-processed with one or more of these steps.

The conversation analyzer 306 can learn over time which features to focus on, and how to weight the features in order to improve the conversation dominance score 314, or the Power Index. Further, while the conversation analyzer 306 can operate on a single interaction, such as a conference call or a meeting, the conversation analyzer 306 can also apply to a group of people that meet regularly, and can provide a picture of the evolution of who plays dominant roles in the group over time. For example, as a younger participant gains experience and grows more confident, his or her dominance in the meetings may increase. The system can send notifications when a participant reaches a particular threshold. This can be useful in training situations, such as when a trainee is sufficiently confident and dominant in sales calls to no longer need a trainer with him or her on every interaction with customers. When the conversation analyzer 306 processes a series of interactions with the same or similar participants, the conversation analyzer 306 can incorporate all or part of a previous interaction into a starting state for the current interaction. In this way, the continuity of dominance and inter-personal relationships is preserved at least partially from one interaction to the next. This approach can be useful to provide a frame of reference when the interactions do not have a score roughly corresponding to the nation-wide or state-wide polls of the example corpus of presidential primary debates. The system can augment a Power Index or conversation dominance score 314 from one interaction to the next with information describing events between the interactions, such as email messages, changes or promotions in an organizational hierarchy, and so forth.

In one variation, the conversation analyzer 306 operates on previously recorded interactions to analyze, after the fact, participants' power indices. However, in one variation, the conversation analyzer 306 analyzes an ongoing interaction and provides real-time or substantially real-time feedback for participants. For example, a participant can view, on his or her device, an indication of who in the interaction has a high conversation dominance score 314 or Power Index. The system can present not only power indices of other participants, but can also show events or underlying reasons for assigning the particular participant that power index or dominance score. A participant can receive, in substantially real time as the interaction is on-going, feedback regarding his or her actions and has a chance to change his or her conduct in the moment. The conversation analyzer 306 can even present suggestions to the participant for improving the dominance score, such as prompting the participant to interrupt, to provide longer answers when asked a question, or to refer to another participant in a response. Alternatively, the conversation analyzer 306 can allow a participant to identify which other participants are more likely to be in positions of power or influence, and can focus sales efforts or other persuasion efforts on those participants.

In the context of a political debate, the output conversation dominance score 314 can be presented as part of the television or internet broadcast of the debate. In sports broadcasts, statistics and other information are often presented along the bottom of the screen to provide viewers a more complete picture of the players and their positions in the game. The conversation dominance score 314 or Power Index can be provided in similar fashion in broadcasts of political debates, providing in real time a way for viewers who may not have time to view the entire debate, a quick way to assess who is more dominant in the debate. In an interactive broadcast venue, such as an Internet-based video delivery service, viewers could even click or tap on the conversation dominance score 314 in the broadcast to view how the score has changed over the course of the debate, and to view replays of specific moments in the debate associated with a change in the conversation dominance score 314. This information can also be useful in high school or college debate classes or competitions.

In a customer service or technical support environment, the system 300 can track a user's power index over multiple telephone or other customer care interactions. Then, the system can match the customer with a compatible agent, or can provide the agent with some indication of the dominance score of the customer, so the agent knows how to interact with that particular customer effectively.

The system can compute in real time a preliminary or “probabilistic” power index for a conversation. Then, as the conversation progresses, the system can change the power index as additional cumulative data is analyzed. For example, the conversation may start out with several strong or clear indicators that one participant has a high power index. As the conversation progresses, other indicators may show that another participant is stronger or that the first participant is weaker than expected. The system can adjust the probabilistic power index for one or more participants. As the system detects these events for each participant, the system can augment a feed of the conversation to indicate these events in real time. For example, the system can overlay a “status bar” in the video feed above each participant's face, reflective of their respective power indices. As the system encounters an event that reduces or increases the power index of a participant, the system can adjust the overlay accordingly. The system can also introduce animations, images, text, or other audio and/or visual components to draw attention to that event, and its impact on the power index of the participant.

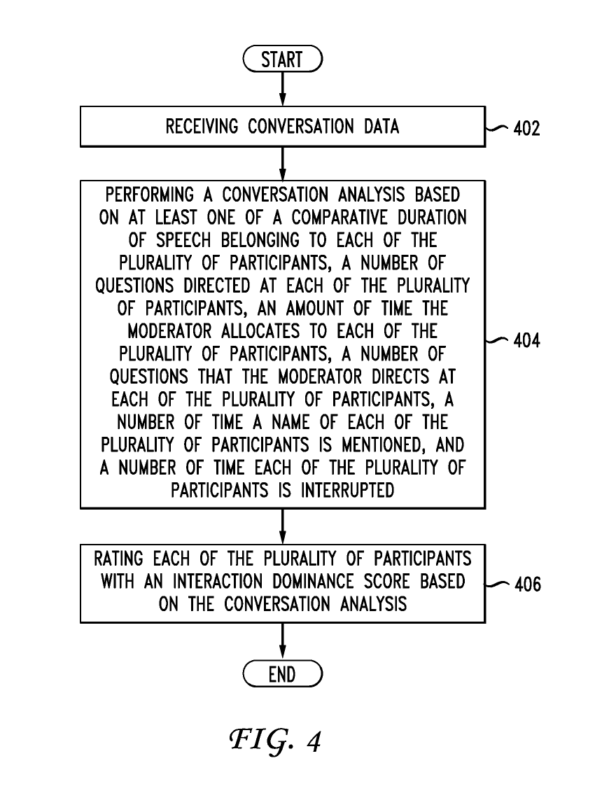

FIG. 4 illustrates an example method embodiment for evaluating participant dominance in interactions. The interactions can be live conversations, telephone conversations, conference calls, video chats, text-based chats, or virtually any form of multi-party communication. A system configured to practice this method can automatically rank participants of an interaction in terms of their relative power based on several linguistic and structural features. Participants' power indices can indicate and also affect the way participants interact with each other, such as how much participants speak, about whom participants speak, and how they refer to other participants. Dominance can affect the way others interact with a given participant, such as how many questions were directed to that participant, how much others interrupt that participant, and how often other talked about that participant.

The example system can receive a conversation involving a moderator and a plurality of participants, wherein the conversation is one of a spoken dialogue and a written transcript (402). The system can analyze the conversation to yield a conversation analysis, wherein the analyzing is based on features of the conversation (404). The conversation analysis can include weighting each feature of the conversation, optionally according to a type of the conversation. Features can include, but are not limited to, a comparative duration of speech belonging to each of the plurality of participants, a number of questions directed at each of the plurality of participants, an amount of time the moderator allocates to each of the plurality of participants, a number of questions that the moderator directs at each of the plurality of participants, a number of times a name of each of the plurality of participants is mentioned, how participants address each other, or a number of times each of the plurality of participants is interrupted. Further, the system can analyze the conversation based not only on features, but also content of the dialog turns by participants.

The system can rate each of the plurality of participants with an interaction dominance score based on the conversation analysis (406). The system can incorporate a previous interaction dominance score received from a previous related conversation, and rate each of the plurality of participants based in part on the previous interaction dominance score. The system can present the interaction dominance score to at least one of an audience, the moderator, or the plurality of participants. Alternatively, the system can store the interaction dominance score in a log or analytics file.

In another variation, the example system can receive interaction data involving a plurality of participants, and identify a type of interaction based on the interaction data. Then the system can parse the interaction data to identify dialog turns, and extract, from the interaction data and dialog turns, a plurality of participant features, wherein the plurality of participant features is selected based on the type of interaction to generate, for each of the plurality of participants, a power index based on the respective participant features.

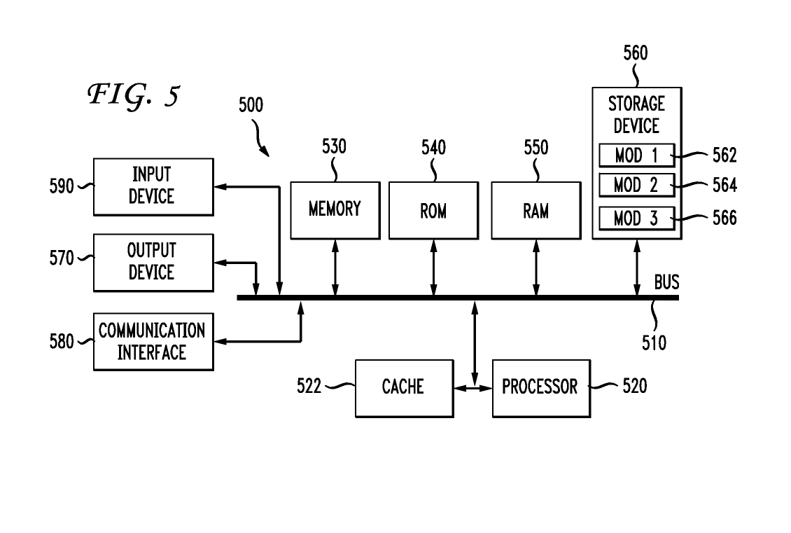

With reference to FIG. 5, an exemplary system 500 includes a general-purpose computing device 500, including a processing unit (CPU or processor) 520 and a system bus 510 that couples various system components including the system memory 530 such as read only memory (ROM) 540 and random access memory (RAM) 550 to the processor 520. The system 500 can include a cache 522 of high speed memory connected directly with, in close proximity to, or integrated as part of the processor 520. The system 500 copies data from the memory 530 and/or the storage device 560 to the cache 522 for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer readable storage media provide nonvolatile storage of computer readable instructions, data structures, program modules and other data for the computing device 500. In one aspect, a hardware module that performs a particular function includes the software component stored in a non-transitory computer-readable medium in connection with the necessary hardware components, such as the processor 520, bus 510, display 570, and so forth, to carry out the function. The basic components are known to those of skill in the art and appropriate variations are contemplated depending on the type of device, such as whether the device 500 is a small, handheld computing device, a desktop computer, or a computer server.

Although the exemplary embodiment described herein employs the hard disk 560, it should be appreciated by those skilled in the art that other types of computer readable media which can store data that are accessible by a computer, such as magnetic cassettes, flash memory cards, digital versatile disks, cartridges, random access memories (RAMs) 550, read only memory (ROM) 540, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 520. The functions these blocks represent may be provided through the use of either shared or dedicated hardware, including, but not limited to, hardware capable of executing software and hardware, such as a processor 520, that is purpose-built to operate as an equivalent to software executing on a general purpose processor. For example the functions of one or more processors presented in FIG. 5 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 540 for storing software performing the operations discussed below, and random access memory (RAM) 550 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 500 shown in FIG. 5 can practice all or part of the recited methods, can be a part of the recited systems, and/or can operate according to instructions in the recited non-transitory computer-readable storage media. Such logical operations can be implemented as modules configured to control the processor 520 to perform particular functions according to the programming of the module. For example, FIG. 5 illustrates three modules Mod1 562, Mod2 564 and Mod3 566 which are modules configured to control the processor 520. These modules may be stored on the storage device 560 and loaded into RAM 550 or memory 530 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply to any graphical representation of open communication lines. Those skilled in the art will readily recognize various modifications and changes that may be made to the principles described herein without following the example embodiments and applications illustrated and described herein, and without departing from the spirit and scope of the disclosure.

We claim:

1. A method comprising:
receiving a conversation involving a moderator and a plurality of participants, wherein the conversation is one of a spoken dialogue and a written transcript;
analyzing, via a processor, the conversation to yield a conversation analysis, wherein the analyzing is based on features of the conversation; and
rating each of the plurality of participants with an interaction dominance score based on the conversation analysis.

2. The method of claim 1, wherein the conversation analysis is performed as the conversation is ongoing.

3. The method of claim 1, further comprising:
receiving, prior to analyzing the conversation, an initial dominance state for the plurality of participants; and
rating each of the plurality of participants with the interaction dominance score further based on the initial dominance state.

4. The method of claim 1, further comprising:
presenting the interaction dominance score for at least one of the plurality of participants incorporated into a feed of the conversation.

5. The method of claim 1, further comprising:
continuing to analyze the conversation based on features of the conversation after rating each of the plurality of participants with the interaction dominance score to yield an additional conversation analysis; and
updating the interaction dominance score for at least one of the plurality of participants during the conversation based on the additional conversation analysis.

6. The method of claim 1, further comprising:
presenting the interaction dominance score to at least one of an audience, the moderator, or the plurality of participants.

7. The method of claim 1, wherein the analyzing is further based on content of the conversation.

8. A system comprising:
a processor;
a memory storing instructions which, when executed by the processor, cause the processor to perform steps comprising:
receiving interaction data involving a plurality of participants;
identifying a type of interaction based on the interaction data;
parsing the interaction data to identify dialog turns;
extracting, from the interaction data and dialog turns, a plurality of participant features, wherein the plurality of participant features is selected based on the type of interaction; and
generating, for each of the plurality of participants, a power index based on the respective participant features.

9. The system of claim 8, the instructions, when executed by the processor, causing the processor to perform steps further comprising:
weighting each of the plurality of participant features.

10. The system of claim 9, wherein each of the plurality of participant features is weighted according to the type of interaction.

11. The system of claim 8, wherein the plurality of participant features comprises at least one of a comparative duration of speech belonging to each of the plurality of participants, a number of questions directed at each of the plurality of participants, an amount of time a moderator allocates to each of the plurality of participants, a number of questions that the moderator directs at each of the plurality of participants, a number of times a name of each of the plurality of participants is mentioned, how participants address each other, or a number of times each of the plurality of participants is interrupted.

12. The system of claim 8, the instructions, when executed by the processor, causing the processor to perform steps further comprising:
receiving a previous interaction dominance score from a previous related conversation; and
rating each of the plurality of participants based in part on the previous interaction dominance score.

13. The system of claim 8, the instructions, when executed by the processor, causing the processor to perform steps further comprising:
presenting the interaction dominance score to at least one of an audience, the moderator, or the plurality of participants.

14. The system of claim 8, wherein generating the power index is further based on content of the interaction.

15. A non-transitory computer-readable storage medium having stored therein instructions which, when executed by a computing device, cause the computing device to perform steps comprising:
receiving interaction data involving a plurality of participants;
identifying a type of interaction based on the interaction data;
extracting, from the interaction data, a plurality of participant features selected based on the type of interaction; and
generating, for each of the plurality of participants, a power index based on the respective participant features.

16. The non-transitory computer-readable storage medium of claim 15, the instructions causing the computing device to perform steps further comprising:
weighting each of the plurality of participant features.

17. The non-transitory computer-readable storage medium of claim 16, wherein each of the plurality of participant features is weighted according to the type of interaction.

18. The non-transitory computer-readable storage medium of claim 15, wherein the plurality of participant features comprises at least one of a comparative duration of speech belonging to each of the plurality of participants, a number of questions directed at each of the plurality of participants, an amount of time a moderator allocates to each of the plurality of participants, a number of questions that the moderator directs at each of the plurality of participants, a number of times a name of each of the plurality of participants is mentioned, how participants address each other, or a number of times each of the plurality of participants is interrupted.

19. The non-transitory computer-readable storage medium of claim 15, the instructions causing the computing device to perform steps further comprising:
receiving a previous interaction dominance score from a previous related conversation; and
rating each of the plurality of participants based in part on the previous interaction dominance score.

20. The non-transitory computer-readable storage medium of claim 15, the instructions causing the computing device to perform steps further comprising:
presenting the interaction dominance score to at least one of an audience, the moderator, or the plurality of participants.
